(19) United States
(12) Patent Application Publication
(10) Pub. No.: US 2005/0241539 A1
(43) Pub. Date: Nov. 3, 2005

(54) Tile cement mortars using water retention agents

(76) Inventors: Wolfgang Hagen, Meerbusch (DE); Wilfried Hohn, Erftstadt (DE); Dieter Schweizer, Duesseldorf (DE)

Correspondence Address: Hercules Incorporated;Hercules Plaza, 1313 North Market Street, Wilmington, DE, 19894-0001, US

(21) Appl. No.: 11/111,226

(22) Filed: Apr. 21, 2005

Related U.S. Application Data
(60) Provisional application No. 60/565,643, filed on Apr. 27, 2004.

(51) Int. Cl. C04B 14/00

(52) U.S. Cl. 106/805

(57) ABSTRACT

A mixture composition of a cellulose ether made from raw cotton linters and at least one additive is used in a dry tile cement composition wherein the amount of the cellulose ether in the tile cement composition is significantly reduced. When this tile cement composition is mixed with water and applied to a substrate, the correction time, applicability, and sag resistance of the wet mortar are comparable or improved as compared to when using conventional similar cellulose ethers.

This application claims the benefit of U.S. Provisional Application No. 60/565,643, filed Apr. 27, 2004.

### FIELD OF THE INVENTION

This invention relates to a mixture composition useful in dry tile cement mortar compositions for installing ceramic tiles on walls and floors. This invention also relates to a dry tile cement mortar using an improved water retention agent that is prepared from raw cotton linters.

### BACKGROUND OF THE INVENTION

Traditional ceramic tile cements are often simple dry mixtures of cement and sand. The dry mixture is mixed with water to form a mortar. These traditional mortars, per se, have poor fluidity or trowellability. Consequently, the application of these mortars is labor intensive, especially in summer months under hot weather conditions, because of the rapid evaporation or removal of water from the mortar which results in inferior or poor workability as well as short open and correction times and insufficient hydration of cement.

The physical characteristics of a hardened traditional mortar are strongly influenced by its hydration process, and thus, by the rate of water removal therefrom during the setting operation. Any influence, which affects these parameters by increasing the rate of water removal or by diminishing the water concentration in the mortar at the onset of the setting reaction, can cause a deterioration of the physical properties of the mortar. Most ceramic tiles, on their unglazed surfaces, are highly porous and can remove a significant amount of water from the mortar leading to the difficulties just mentioned. Likewise, most substrates to which these tiles are applied, such as lime sandstone, cinderblock, wood or masonry, are also porous and lead to the same problems.

To overcome, or to minimize, the above mentioned water-loss problems, the prior art discloses uses of cellulose ethers as water retention agents to mitigate this problem. An example of this prior art is U.S. Pat. No. 4,501,617 that discloses the use of hydroxypropylhydroxyethylcellulose (HPHEC) as a water retention aid for improving trowellability or fluidity of mortar. The uses of cellulose ethers in dry-mortar applications are also disclosed in DE 3909070, DE3913518, CA2456793, and EP 773198.

German publication 4,034,709 A1 discloses the use of raw cotton linters to prepare cellulose ethers as additives to cement based hydraulic mortars or concrete compositions.

Cellulose ethers (CEs) represent an important class of commercially important water-soluble polymers. These CEs are capable of increasing viscosity of aqueous media. The viscosifying ability of a CE is primarily controlled by its molecular weight, chemical substituents attached to it, and conformational characteristics of the polymer chain. CEs are used in many applications, such as construction, paints, food, personal care, pharmaceuticals, adhesives, detergents/cleaning products, oilfield, paper industry, ceramics, polymerization processes, leather industry, and textile. Methylcellulose (MC), methylhydroxyethylcellulose (MHEC), ethylhydroxyethylcellulose (EHEC), methylhydroxypropylcellulose (MHPC), hydroxyethylcellulose (HEC), hydrophobically modified hydroxyethylcellulose (HMHEC) either alone or in combination are widely used for dry mortar formulations in the construction industry. By a dry mortar formulation is meant a blend of gypsum, cement, and/or lime as the inorganic binder used either alone or in combination with aggregates (e.g., silica and/or carbonate sand/powder), and additives.

For their end-use application, these dry mortars are mixed with water and applied as wet materials. For the intended applications, water-soluble polymers that give high viscosity upon dissolution in water are required. By using MC, MHEC, MHPC, EHEC, HEC, and HMHEC or combinations thereof, desired mortar properties such as high water retention (and consequently a defined control of water content) are achieved. Additionally, an improved workability and satisfactory adhesion of the resulting material can be observed. Since an increase in CE solution viscosity results in improved water retention capability and adhesion, high molecular weight CEs providing high solution viscosity are desirable in order to work more efficiently and cost effectively. In order to achieve high solution viscosity, the starting cellulose ether has to be selected carefully. Currently, by using purified cotton linters or very high viscosity wood pulps, the highest 2 wt % aqueous solution viscosity that can be achieved by alkylhydroxyalkylcelluloses is about 70,000-80,000 mPas (as measured using a Brookfield RVT viscometer at 20° C. and 20 rpm, using a spindle number 7).

A need still exists in the tile cement mortar industry for having a water retention agent that can be used in a cost-effective manner to improve the application and performance properties of tile cement mortars. In order to assist in achieving this result, it would be preferred to provide a water retention agent that provides a 2% aqueous solution Brookfield viscosity of preferably greater than about 80,000 mPas and still be cost effective for use as a thickener and/or water retention agent.

### SUMMARY OF THE INVENTION

The present invention relates to a mixture composition for use in a dry mortar tile cement composition of a cellulose ether in an amount of 20 to 99.9 wt % of alkylhydroxyalkylcelluloses and hydroxyalkylcelluloses and mixtures thereof, prepared from raw cotton linters, and at least one additive in an amount of 0.1 to 80 wt % of organic or inorganic thickening agents, anti-sag agents, air entraining agents, wetting agents, defoamers, superplasticizers, dispersants, calcium-complexing agents, retarders, accelerators, water repellants, redispersible powders, biopolymers, and fibres; the mixture composition, when used in a dry tile cement formulation and mixed with a sufficient amount of water, the tile cement formulation produces a mortar which can be applied to substrates wherein the amount of the mixture in the mortar is significantly reduced while correction time, applicability, and sag-resistance of the wet mortar are comparable or improved as compared to when using conventional similar cellulose ethers.

The present invention is also directed to a dry tile cement mortar composition of hydraulic cement, fine aggregate material, and a water-retaining agent of at least one cellulose ether prepared from raw cotton linters; the dry tile cement mortar composition, when mixed with a sufficient amount of water, produces a mortar which can be applied in thin layers for setting tile on substrates wherein the amount of the water retention agent in the mortar is significantly reduced while correction time, applicability, and sag-resistance of the mortar are comparable or improved as compared to when using conventional similar cellulose ethers.

### DETAILED DESCRIPTION OF THE INVENTION

It has been surprisingly found that certain cellulose ethers, particularly alkylhydroxyalkylcelluloses and hydroxyalkylcelluloses, made from raw cotton linters (RCL) have unusually high solution viscosity relative to the viscosity of conventional, commercial cellulose ethers made from purified cotton linters or high viscosity wood pulps. The use of these cellulose ethers in tile cement mortars provide several advantages (i.e., lower cost in use and better application properties) and improved performance properties that were hitherto not possible to achieve using conventional cellulose ethers.

In accordance with this invention, cellulose ethers of alkylhydroxyalkylcelluloses and hydroxyalkylcelluloses are prepared from cut or uncut raw cotton linters. The alkyl group of the alkylhydroxyalkylcelluloses has 1 to 24 carbons atoms and the hydroxyalkyl group has 2 to 4 carbon atoms. Also, the hydroxyalkyl group of the hydroxyalkylcelluloses has 2 to 4 carbon atoms. These cellulose ethers provided unexpected and surprising benefits to the tile cement mortars. Because of the extremely high viscosity of the RCL-based CEs, very efficient application performance in tile cements could be observed. Even at lower use level of the RCL based CEs as compared to currently used high viscosity commercial CEs, similar or improved application performance with respect to water retention and consequently correction time are achieved.

It also has been demonstrated that alkylhydroxyalkylcelluloses and hydroxyalkylcelluloses, such as methylhydroxyethylcelluloses, methylhydroxypropylcelluloses, hydroxyethylcelluloses, and hydrophobically modified hydroxyethylcelluloses, prepared from RCL give significant body and improved sag-resistance to mortars. Since mortars prepared using these RCL based CEs have improved ability to retain water, they provide longer correction times, even at reduced CE use levels. Moreover, these RCL based CEs in mortars showed a lubricating effect that positively influences applicability with the notched trowel. The use of these RCL based CEs in mortars reduces surface tension and increases amount of the make-up water required. Consequently, it is easy to mix the dry-mortar tile cement product with water.

In accordance with the present invention, the mixture composition has an amount of the cellulose ether of 20 to 99.9 wt %, preferably 70 to 99.0 wt %.

The RCL based, nonionic CEs of the present invention include (as primary CEs), particularly, alkylhydroxyalkylcelluloses and hydroxyalkylcelluloses made from raw cotton linters (RCL). Examples of such derivatives include methylhydroxyethylcelluloses (MHEC), methylhydroxypropylcelluloses (MHPC), methylethylhydroxyethylcelluloses (MEHEC), ethylhydroxyethylcelluloses (EHEC), hydrophobically modified ethylhydroxyethylcelluloses (HMEHEC), hydroxyethylcelluloses (HEC), hydrophobically modified hydroxyethylcelluloses (HMHEC), and mixtures thereof. The hydrophobic substituent can have 1 to 25 carbon atoms. Depending on their chemical composition, they can have a methyl or ethyl degree of substitution (DS) of 0.5 to 2.5, a hydroxyalkyl molar substitution (HA-MS) of about 0.01 to 6, and a hydrophobic substituent molar substitution (HS-MS) of about 0.01 to 0.5 per anhydroglucose unit. More particularly, the present invention relates to the use of these water-soluble, nonionic CEs as efficient thickener and/or water retention agents in dry-mortar tile cement applications.

In practicing the present invention, conventional CEs made from purified cotton linters and wood pulps (secondary CEs) can be used in combination with RCL based CEs. The preparation of various types of CEs from purified celluloses is known in the art. These secondary CEs can be used in combination with the primary RCL-CEs for practicing the present invention. These secondary CEs will be referred to in this application as conventional CEs because most of them are commercial products or known in the marketplace and/or literature.

Examples of the secondary CEs are methylcellulose (MC), methylhydroxyethylcellulose (MHEC), methylhydroxypropylcellulose (MHPC), hydroxyethylcellulose (HEC), ethylhydroxyethylcellulose (EHEC), hydrophobically modified hydroxyethylcellulose (HMHEC), hydrophobically modified ethylhydroxyethylcellulose (HMEHEC), methylethylhydroxyethylcellulose (MEHEC), sulfoethyl methylhydroxyethylcelluloses (SEMHEC), sulfoethyl methylhydroxypropylcelluloses (SEMHPC), and sulfoethyl hydroxyethylcelluloses (SEHEC).

In accordance with the present invention, one preferred embodiment makes use of MHEC and MHPC, made from RCL, having an aqueous Brookfield solution viscosity of greater than 80,000 mPas, preferably greater than 90,000 mPas, as measured on a Brookfield RVT viscometer at 20° C., 20 rpm, and a concentration of 2 wt % using spindle number 7.

In accordance with the present invention, the mixture composition has an amount of at least one additive of between 0.1 and 80 wt %, preferably between 0.5 and 30 wt %. The additives used include organic or inorganic thickening agents and/or secondary water retention agents, anti-sag agents, air entraining agents, wetting agents, defoamers, superplasticizers, dispersants, calcium-complexing agents, retarders, accelerators, water repellants, redispersible powders, biopolymers, and fibres. An example of the organic thickening agent is polysaccharides. Other examples of additives are calcium chelating agents, fruit acids, and surface active agents.

More specific examples of the above additives are homo- or co-polymers of acrylamide. Examples of such polymers are of poly(acrylamide-co-sodium acrylate), poly(acrylamide-co-acrylic acid), poly(acrylamide-co-sodium-acrylamido methylpropanesulfonate), poly(acrylamide-co-acrylamido methylpropanesulfonic acid), poly(acrylamide-co-diallyidimethylammonium chloride), poly(acrylamide-co-(acryloylamino)propyltrimethylammoniumchloride), poly(acrylamide-co-(acryloyl)ethyltrimethylammoniumchloride), and mixtures thereof.

Examples of the polysaccharide additives are starch ether, starch, guar/guar derivatives, dextran, chitin, chitosan, xylan, xanthan gum, welan gum, gellan gum, mannan, galactan, glucan, alginate, arabinoxylan, and cellulose fibres.

Other specific examples of the additives are gelatin, polyethylenegylcol, casein, lignin sulfonates, naphthalene-sulfonate, sulfonated melamine-formaldehyde condensate, sulfonated naphthalene-formaldehyde condensate, polyacrylates, polycarboxylateether, polystyrene sulphonates, phosphates, phosphonates, calcium-salts of organic acids having 1 to 4 carbon atoms, salts of alkanoates, aluminum sulfate, metallic aluminum, bentonite, montmorillonite, sepiolite, polyamide fibres, polypropylene fibres, polyvinyl alcohol, and homo-, co-, or terpolymers based on vinyl acetate, maleic ester, ethylene, styrene, butadiene, vinyl versatate, and acrylic monomers.

The mixture compositions of this invention can be prepared by a wide variety of techniques known in the prior art. Examples include simple dry blending, spraying of solutions or melts onto dry materials, co-extrusion, or co-grinding.

In accordance with the present invention, the mixture composition when used in a dry tile cement formulation and mixed with a sufficient amount of water to produce a tile cement mortar, the amount of the mixture, and consequently the cellulose ether, is significantly reduced. The reduction of the mixture or cellulose ether is at least 5%, preferably 10%. Even with such reductions in the CE, the correction time, applicability, and sag-resistance of the wet mortar are comparable or improved as compared to when using conventional similar cellulose ethers.

The mixture composition of the present invention can be marketed directly or indirectly to tile cement manufacturers who can use such mixtures directly into their manufacturing facilities. The mixture composition can also be custom blended to preferred requirements of different manufacturers.

The dry tile cement composition of the present invention has an amount of CE of from about 0.1 to 2.0 wt %. The amount of the at least one additive is from about 0.001 to 15 wt %. These weight percentages are based on the total dry weight of all of the ingredients of the dry tile cement composition.

In accordance with the present invention, the dry tile cement mortar composition has the fine aggregate material present in the amount of 20-90 wt %, preferably in the amount of 50-70 wt %. Examples of the fine aggregate material are silica sand, dolomite, limestone, lightweight aggregates (e.g. perlite, expanded polystyrene, hollow glass spheres), rubber crumbs (recycled from car tires), and fly ash. By “fine” is meant that the aggregate materials have particle sizes up to 1.0 mm, preferably 0.5 mm.

In accordance with the present invention, the hydraulic cement component is present in the amount of 10-80 wt %, and preferably in the amount of 20-50 wt %. Examples of the hydraulic cement are Portland cement, Portland-slag cement, Portland-silica fume cement, Portland-pozzolana cement, Portland-burnt shale cement, Portland-limestone cement, Portland-composite cement, blastfurnace cement, pozzolana cement, composite cement and calcium aluminate cement.

The dry tile cement mortar composition of the present invention can also have in combination therewith at least one mineral binder of hydrated lime, gypsum, pozzolana, blast furnace slag, and hydraulic lime. The at least one mineral binder can be present in the amount of 0.1-30 wt %.

According to the present invention, a preferred embodiment is a mixture and consequently a dry tile cement composition containing MHEC or MHPC and an additive of homo-or co-polymers of acrylamide, starch ether, or mixtures thereof. In this embodiment, each of the MHEC and MHPC has a Brookfield aqueous solution viscosity of greater than 80,000 mpas, preferably greater than 90,000 mPas, as measured on a Brookfield RVT viscometer at 2 wt %, 20° C., and 20 rpm using a spindle number 7.

In accordance with a preferred embodiment of the invention, cellulose ethers are prepared according to U.S. patent application Ser. No. 10/822,926, filed Apr. 13, 2004, which is herein incorporated by reference. The starting material of this embodiment of the present invention is a mass of unpurified raw cotton linter fibers that has a bulk density of at least 8 grams per 100 ml. At least 50 wt % of the fibers in this mass have an average length that passes through a US sieve screen size number 10 (2 mm openings). This mass of unpurified raw cotton linters is prepared by obtaining a loose mass of first cut, second cut, third cut and/or mill run unpurified, natural, raw cotton linters or mixtures thereof containing at least 60% cellulose as measured by AOCS (American Oil Chemists' Society) Official Method Bb 3-47 and comminuting the loose mass to a length wherein at least 50 wt % of the fibers pass through a US standard sieve size no. 10. The cellulose ether derivatives are prepared using the above-mentioned comminuted mass of raw cotton linter fibers as the starting material. The cut mass of raw cotton linters is first treated with a base in a slurry or high solids process at a cellulose concentration of greater than 9 wt % to form an activated cellulose slurry. Then, the activated cellulose slurry is reacted for a sufficient time and at a sufficient temperature with an etherifying agent or a mixture of etherifying agents to form the cellulose ether derivative, which is then recovered. The modification of the above process to prepare the various CEs of the present invention is well known in the art.

The CEs of this invention can also be prepared from uncut raw cotton linters that are obtained in bales of the RCL that are either first, second, third cut, and/or mill run from the manufacturer.

Raw cotton linters including compositions resulting from mechanical cleaning of raw cotton linters, which are substantially free of non-cellulosic foreign matter, such as field trash, debris, seed hulls, etc., can also be used to prepare cellulose ethers of the present invention. Mechanical cleaning techniques of raw cotton linters, including those involving beating, screening, and air separation techniques, are well known to those skilled in the art. Using a combination of mechanical beating techniques and air separation techniques fibers are separated from debris by taking advantages of the density difference between fibers and debris. A mixture of mechanically cleaned raw cotton linters and “as is” raw cotton linters can also be used to manufacture cellulose ethers.

When compared with the mortars prepared with conventional cellulose ethers as the water retention agent, the performance of the mortars of this invention are improved with regard to correction time, applicability, and sag-resistance. These are important parameters used widely in the art to characterize the performance of tile cement mortars.

“Correction time” is defined as the time during which the position of the tile on the wall can be changed without the tile coming loose from the mortar.

“Applicability” is defined as the ease of applying the tile cement to a substrate, such as floor or wall surfaces. Applicability is rated subjectively by the craftsman, and is a description of how easy it is to spread the mortar onto the substrate.

“Sag-resistance” is the ability of a vertically applied tile cement to fix a tile in position where it was embedded into the mortar bed so that the tile does not slide down.

A typical dry tile cement mortar might contain some or all of the following components:

TABLE A
Typical Prior Art Composition of Tile Cement

| | Typical | |
|---|---|---|
| Component | amount | Examples |
| Cement | 10-80% | CEM I (Portland cement), CEM II, CEM III |
| | | (blast-furnace cement), CEM IV (pozzolana |
| | | cement), CEM V (composite cement), CAC |
| | | (calcium aluminate cement) |
| Other | 0-5% | hydrated lime, gypsum, lime, pozzolana, blast |
| mineral | | furnace slag, and hydraulic lime |
| binders | | |
| Aggregate | 20-90% | silica sand, dolomite, limestone, expanded |
| | | lightweights, fly ash |
| Spray dried | 0-20% | homo-, co-, or terpolymers based on vinylacetate, |
| resin | | maleic ester, ethylene, styrene, butadiene, |
| | | versatate, and/or acrylic monomers |
| Accelerator | 0-2% | calcium formate, sodium carbonate, lithium |
| | | carbonate |
| Fiber | 0-2% | cellulose fibre, polyamide fibre, polypropylene |
| | | fibre |
| Cellulose | 0-2% | Methylcellulose (MC), |
| ether | | methylhydroxyethylcellulose (MHEC), |
| | | methylhydroxypropylcellulose (MHPC), |
| | | ethylhydroxyethylcellulose (EHEC), |
| | | hydroxyethylcellulose (HEC)/ |
| | | hydrophobically modified |
| | | hydroxyethylcellulose (HMHEC) |
| Other | 0-2% | Polyacrylamide, starch ether |
| additives | | |

The invention is further illustrated by the following Examples. Parts and percentages are by weight, unless otherwise noted.

### EXAMPLE 1

Examples 1 and 2 show some of the chemical and physical properties of the polymers of the instant invention as compared to similar commercial polymers.

Determination of Substitution

Cellulose ethers were subjected to a modified Zeisel ether cleavage at 150° C. with hydriodic acid. The resulting volatile reaction products were determined quantitatively with a gas chromatograph.

Determination of Viscosity

The viscosities of aqueous cellulose ether solutions were determined on solutions having concentrations of 1 wt % and 2 wt %. When ascertaining the viscosity of the cellulose ether solution, the corresponding methylhydroxyalkylcellulose was used on a dry basis, i.e., the percentage moisture was compensated by a higher weight-in quantity. Viscosities of currently available, commercial methylhydroxyalkylcelluloses, which are based on purified cotton linters or high viscous wood pulps have maximum 2 wt % aqueous solution viscosity of about 70,000 to 80,000 mPas (as measured using Brookfield RVT viscometer at 20° C. and 20 rpm, using a spindle number 7).

In order to determine the viscosities, a Brookfield RVT rotation viscometer was used. All measurements at 2 wt % aqueous solutions were made at 20° C. and 20 rpm, using spindle number 7.

Sodium Chloride Content

The sodium chloride content was determined by the Mohr method. 0.5 g of the product was weighed on an analytical balance and was dissolved in 150 ml of distilled water. 1 ml of 15% HNO₃ was then added after 30 minutes of stirring. Afterwards, the solution was titrated with normalized silver nitrate (AgNO₃) solution using a commercially available apparatus.

Determination of Moisture

The moisture content of the sample was measured using a commercially available moisture balance at 105° C. The moisture content was the quotient from the weight loss and the starting weight, and is expressed in percent.

Determination of Surface Tension

The surface tensions of the aqueous cellulose ether solutions were measured at 20° C and a concentration of 0.1 wt % using a Krüss Digital-Tensiometer K10. For determination of surface tension the so-called “Wilhelmy Plate Method” was used, where a thin plate is lowered to the surface of the liquid and the downward force directed to the plate is measured.

TABLE 1
Analytical Data

| | Methoxyl/ | | | | |
|---|---|---|---|---|---|
| | Hydroxyethoxyl | Viscosity | | | |
| | or | on dry basis | | Mois- | Surface |
| | hydroxypropoxyl | at 2 wt-% | at 1 wt-% | ture | tension* |
| Sample | [%] | [mPas] | [mPas] | [%] | [mN/m] |
| RCL- | 26.6/2.9 | 95400 | 17450 | 2.33 | 35 |
| MHPC | | | | | |
| MHPC | 27.1/3.9 | 59800 | 7300 | 4.68 | 48 |
| 65000 | | | | | |
| (control) | | | | | |
| RCL- | 23.3/8.4 | 97000 | 21300 | 2.01 | 43 |
| MHEC | | | | | |
| MHEC | 22.6/8.2 | 67600 | 9050 | 2.49 | 53 |
| 75000 | | | | | |
| (control) | | | | | |

*0.1 wt-% aqueous solution at 20° C.

Table 1 shows the analytical data of a methylhydroxyethylcellulose and a methylhydroxypropylcellulose derived from RCL. The results clearly indicate that these products have significantly higher viscosities than current, commercially available high viscous types. At a concentration of 2 wt %, viscosities of about 100,000 mPas were found. Because of their extremely high values, it was more reliable and easier to measure viscosities of 1 wt % aqueous solutions. At this concentration, commercially available high viscous methylhydroxyethylcelluloses and methylhydroxypropylcelluloses showed viscosities in the range of 7300 to about 9000 mPas (see Table 1). The measured values for the products based on raw cotton linters were significantly higher than the commercial materials. Moreover, the data in Table 1 clearly indicate that the cellulose ethers which are based on raw cotton linters have lower surface tensions than the control samples.

### EXAMPLE 2

Determination of Substitution

Cellulose ethers were subjected to a modified Zeisel ether cleavage at 150° C. with hydriodic acid. The resulting volatile reaction products were determined quantitatively with a gas chromatograph.

Determination of Viscosity

The viscosities of aqueous cellulose ether solutions were determined on solutions having concentrations of 1 wt %. When ascertaining the viscosity of the cellulose ether solution, the corresponding hydroxyethylcellulose was used on a dry basis, i.e., the percentage moisture was compensated by a higher weight-in quantity.

In order to determine the viscosities, a Brookfield LVF rotation viscometer was used. All measurements were made at 25° C. and 30 rpm, using a spindle number 4.

Hydroxyethylcelluloses were made from purified as well as raw cotton linters in Hercules' pilot plant reactor. As indicated in Table 2, both samples have about the same hydroxyethoxyl-content. But viscosity of the resulting HEC based on RCL is about 23% higher.

TABLE 2
Analytical Data of HEC-samples

| | Hydroxyethoxyl | At 1 wt % |
|---|---|---|
| | [%] | [mPas] |
| Purified linters HEC | 58.7 | 3670 |
| RCL-HEC | 57.1 | 4530 |

### EXAMPLE 3

All tests were conducted in tile cement of 30.00 wt % Portland cement (CEM I 42,5 R), 69.70 wt % silica sand (0.1-0.3 mm in diameter), and 0.30 wt % of cellulose ether.

For quality assessment various test methods were applied. Water demand was adjusted to achieve comparable (550,000±50,000 mPas) Helipath viscosity.

Determination of Mortar Viscosity

The determination of mortar consistency was carried out by means of rotating viscometer and spindle system (Helipath device).

Determination of Open Time and Correction Time

For open time determination, mortar was applied with notched spreader (6×6 mm) on fibre cement slab. Every five minutes 5×5 cm earthenware and stoneware tiles were embedded by loading with a 2 kg weight for 30 seconds. Open time was finished when less then 50% of the backside of the tile was covered with mortar. First mentioned value stands for open time in case of earthenware tiles, second for stoneware ceramics.

The capability of the mortar to keep the water enclosed for a certain time period was expressed in the correction time or also called adjustability. The mortar was applied on a lime sandstone brick and several tiles were embedded by hand. The adjustability was checked every few minutes by turning one of the tiles by a slight angle in both directions with low power. With loss of water the consistency of the mortar bed increased until turning of the tile leads to loss of adhesion.

Anti-sag Behaviour

The application of ceramic tiles on vertical substrates required a certain stand up performance of tile cement. The mortar was applied on a horizontally positioned polyvinyl chloride (PVC) plate with a 6×6 mm trowel and a stoneware tile of 10×10 cm (weight 200 g) was embedded by applying a load of 2 kg weight for 30 seconds. The plate was placed vertically and the sag was measured after 10 minutes.

Setting Behavior

Setting behavior of the tile cements was investigated according to DIN EN 196-3 procedure using a Vicat needle device. The freshly prepared mortar was filled into a ring and a needle was dropped down and penetrated the mortar as long as plasticity allowed. During setting and/or hardening of the mortar, penetration became less. The beginning and ending of the test were defined in hours and minutes according to a certain penetration in millimeter.

Methylhydroxyethylcellulose (MHEC) and methylhydroxypropylcellulose (MHPC) made from RCL were tested in the above-mentioned tile cement composition and their performances were compared against those of commercially available, high viscosity MHEC and MHPC (from Hercules) as control samples. The results are shown in Table 3.

TABLE 3
Testing of different cellulose ethers in tile cement application
(23° C./50% relative air humidity)

| | | | Helipath | | | Correc- |
|---|---|---|---|---|---|---|
| | | | mortar | | Open time | tion |
| Cellulose | Dosage | Water | viscosity | Sagging | EW/SW* | time |
| ether | [%] | factor** | [mPas] | [mm] | [min] | [min] |
| MHEC | 0.3 | 0.24 | 570000 | 6 | 20/20 | 19 |
| 75000 | | | | | | |
| MHEC | 0.27 | 0.23 | 550000 | 6 | 15/20 | 16 |
| 75000 | | | | | | |
| RCL | 0.27 | 0.255 | 550000 | 4 | 25/30 | 16 |
| MHEC | | | | | | |
| MHPC | 0.3 | 0.24 | 550000 | 9 | 25/30 | 14 |
| 65000 | | | | | | |
| MHPC | 0.27 | 0.23 | 540000 | 7 | 20/25 | 12 |
| 65000 | | | | | | |
| RCL | 0.27 | 0.255 | 560000 | 11 | 25/30 | 15 |
| MHPC | | | | | | |

*EW = earthenware tiles; SW = stoneware tiles
**water factor: amount of used water divided by amount of used dry mortar, e.g. 20 g of water on 100 g of dry mortar results in a water factor of 0.2

Consistency of the resulting tile cement was adjusted to 550,000 (±50,000) mPas. To achieve the target consistency, the water demand for the RCL-CE based tile cements was higher than that of commercially available methylhydroxyalkylcelluloses. Even at reduced use level (0.27 wt % instead of 0.30 wt %) water factor was still higher, i.e. the RCL-based samples had a stronger thickening effect.

At the reduced dosage, RCL-MHEC based tile cement showed an improvement in open time as compared to the control MHEC at both “typical” and reduced addition levels. This effect might results from the higher water ratio of this sample. Nevertheless, sag-resistance of the resulting mortar was slightly improved.

When the performances of RCL-MHPC and commercial MHPC 65000 were compared at the same addition level, clear advantages for the RCL-MHPC over commercial MHPC 65000 were observed with respect to open time and correction time. The sag-resistance of the RCL-MHPC was slightly reduced, probably due to its significantly higher water demand.

Normally, using the same CE addition level, an increase in water factor results in a dilution of cellulose ether concentration and consequently in shorter correction times. Although water demand of the RCL-MHEC based tile cement at the same addition level was higher in comparison to the mortar containing MHEC 75000, correction time was still comparable.

Although RCL-MHPC was added at a 10% reduced dosage level as compared to the MHPC 65000, similar correction times for the resulting tile cements were observed.

Taking into consideration the test conditions (23° C. and 50% relative air humidity) and the composition of the tile cement basic-mixture as well as the experimental error (±1-2 min.), all determined correction times were good. This positive result was due to the very high viscosities of the investigated samples.

All tests run on samples made from RCL gave a significantly improved body to the mortars. Surprisingly, these products showed a lubricating effect that positively influenced the application with a notched trowel. Because the RCL-CE samples reduced the surface tension of the make-up water (see Example 1), the addition of RCL-CE samples resulted in an easier mixing behavior of the final construction material.

The results indicated that at a 10% reduced addition level of the RCL-MHECs or RCL-MHPCs, they performed comparable or better than the control MHEC or MHPC samples, which were tested at “typical” dosages.

### EXAMPLE 4

All tests were conducted in tile cement of 30.00 wt % Portland cement is (CEM I 42,5 R), 69.70 wt % silica sand (0.1-0.3 mm in diameter), and 0.30 wt % of cellulose ether. Water demand of the samples was adjusted to achieve comparable (550,000±50,000 mpas) consistency.

Determination of Mortar Viscosity, Open Time and Correction Time

Mortar viscosity, open time and correction time were determined, as described in Example 3.

In another series of tests, methylhydroxyethylcellulose (MHEC) and methylhydroxypropylcellulose (MHPC) made from RCL were blended with polyacrylamide and/or hydroxypropyl starch (a starch ether, abbreviated STE).

The polyacrylamide (PAA) used had a molecular weight of 8 to 15 million g/mol, a density of 825±50 g/dm³; and an anionic charge of 15-50 wt %.

The hydroxypropyl starch (STE) had a hydroxypropoxyl-content of 10-35 wt %, a bulk density of 350-550 g/dm³, a moisture content as packed of max. 8 wt %, particle size (Alpine air sifter) of max. 20 wt % residue on 0.4 mm sieve, and a solution viscosity (at 10 wt %, Brookfield RVT, 20 rpm, 20° C.) of 1500-3000 mPas.

These additives (PAA and STE) were tested in the above-mentioned tile cement composition in comparison to modified, high viscosity MHEC and MHPC, respectively, as control samples which were blended accordingly. The results are shown in Table 4.

TABLE 4
Investigation of modified MHECs and MHPCs in tile cement
application (23° C./50% rel. air humidity)

| | Dosage | | Helipath | | | |
|---|---|---|---|---|---|---|
| | (on basic- | Water | mortar | | Open time | Correction |
| | mixture) | factor | viscosity | Sagging | EW/SW* | time |
| | [wt %] | (WF) | [mPas] | [mm] | [min] | [min] |
| MHEC 75000 + 4.0% | 0.30 | 0.24 | 530.000 | 2 | 15/20 | 17 |
| STE + 0.5% | | | | | | |
| PAA | | | | | | |
| MHEC 75000 + 4.0% | 0.27 | 0.23 | 560.000 | 3 | 15/15 | 14 |
| STE + 0.5% | | | | | | |
| PAA | | | | | | |
| RCL-MHEC + 4.0% | 0.27 | 0.25 | 590.000 | 2 | 15/20 | 17 |
| STE + 0.5% | | | | | | |
| PAA | | | | | | |
| MHPC 65000 + 0.5% | 0.30 | 0.24 | 580.000 | 3 | 20/25 | 15 |
| PAA | | | | | | |
| MHPC 65000 + 0.5% | 0.27 | 0.23 | 550.000 | 3 | 20/20 | 12 |
| PAA | | | | | | |
| RCL-MHPC, + 0.5% | 0.27 | 0.25 | 580.000 | 4 | 20/30 | 14 |
| PAA | | | | | | |

*EW = earthenware tiles; SW = stoneware tiles

To achieve the target consistency of 550,000 (±50,000) mpas, the water demand for the modified RCL-CE based tile cements was higher than that of commercially available modified methylhydroxyalkylcellulose based tile cements (controls). Even at reduced use level (0.27 wt % instead of 0.30 wt %) water factor of the RCL-CEs was still higher, i.e. the RCL-based samples had a stronger thickening effect.

At the reduced dosage level, modified RCL-CE based tile cements showed open times, which were at least comparable to the corresponding control samples at both “typical” and reduced addition levels.

Although addition level of both RCL-CEs was 10% lower, correction time of the resulting mortars was still comparable to tile cements containing the corresponding control samples used at “typical” dosage level.

As mentioned above addition of modified RCL-CE gave a significantly improved body or thickening efficiency to the mortars. Nevertheless, these products showed a lubricating effect that positively improved the application using a notched trowel. Because the RCL-CEs reduce surface tension of the make-up water (see Example 1), the addition of modified RCL-CE resulted in an easier mixing behavior of the final construction material.

The results indicated that at a 10% reduced addition level, modified RCL-MHEC or MHPC performed comparable or better than the corresponding control samples, which were tested at “typical” dosage.

### EXAMPLE 5

All tests were conducted in tile cement of 30.00 wt % Portland cement (CEM I 42,5 R), 69.75 wt % silica sand (0.1-0.3 mm in diameter), and 0.25 wt % of cellulose ether.

Water demand was adjusted for all tests to achieve comparable (550,000±50,000 mpas) consistency.

Determination of Mortar Viscosity, Open Time and Correction Time

Mortar viscosity, open time and correction time were determined, as described in Example 3.

In this series of tests, HEC made from RCL was compared to HEC made from purified linters as control with respect to application performance in tile cement. The results are shown in Table 5.

TABLE 5
Investigation of HECs in tile cement application
(23° C./50% rel. air humidity)

| Cellulose | | | | | | | |
|---|---|---|---|---|---|---|---|
| ether | | | | Open | | | |
| (dosage on | | | Helipath | time | Correction | | Setting |
| basic- | | Sagging | viscosity | EW/SW | time | | time |
| mixture) | WF | (mm) | (mPas) | (min) | (min) | Workability | (h) |
| 0.25 wt % | 0.19 | 1 | 510000 | 5/5 | 8 | poor | 27 |
| purified | | | | | | | |
| linters-based | | | | | | | |
| HEC | | | | | | | |
| 0.25 wt % | 0.19 | 1 | 560000 | 5/10 | 11 | poor | 28 |
| RCL-HEC | | | | | | | |
| 0.225 wt % | 0.19 | 1 | 550000 | 5/5 | 8 | poor | 27 |
| RCL-HEC | | | | | | | |

*EW = earthenware tiles; SW = stoneware tiles

In all tests, a water factor of 0.19 was used. At the same addition level lo the tile cement containing RCL-HEC showed a longer correction time, whereas all other investigated properties were comparable to the control sample. When the dosage level of RCL-HEC was reduced by 10%, exactly the same application performance in comparison to the control-sample was observed.

Although the invention has been described with reference to preferred embodiments, it is to be understood that variations and modifications in form and detail thereof may be made without departing from the spirit and scope of the claimed invention. Such variations and modifications are to be considered within the purview and scope of the claims appended thereto.

1. A mixture composition for use in a dry tile cement composition comprising
a) a cellulose ether in an amount of 20 to 99.9 wt % selected from the group consisting of alkylhydroxyalkyl celluloses and hydroxyalkyl celluloses and mixtures thereof, prepared from raw cotton linters, and
b) at least one additive in an amount of 0.1 to 80 wt % selected form the group consisting of organic or inorganic thickening agents, anti-sag agents, air entraining agents, wetting agents, defoamers, superplasticizers, dispersants, calcium-complexing agents, retarders, accelerators, water repellants, redispersible powders, biopolymers, and fibres,
wherein the mixture composition, when used in a dry tile cement formulation and mixed with a sufficient amount of water, the tile cement formulation produces a mortar which can be applied on substrates wherein the amount of the mixture in the mortar is significantly reduced while correction time, applicability, and sag resistance of the wet mortar are comparable or improved as compared to when using conventional similar cellulose ethers.

2. The mixture composition of claim 1 wherein the alkyl group of the alkylhydroxyalkyl cellulose has 1 to 24 carbon atoms, and the hydroxyalkyl group has 2 to 4 carbon atoms.

3. The mixture composition of claim 1 wherein the cellulose ether is selected from the group consisting of methylhydroxyethylcelluloses (MHEC), methylhydroxypropylcelluloses (MHPC), hydroxyethylcellulose (HEC), ethylhydroxyethylcelluloses (EHEC), methylethylhydroxyethylcelluloses (MEHEC), hydrophobically modified ethylhydroxyethylcelluloses (HMEHEC), hydrophobically modified hydroxyethylcelluloses (HMHEC) and mixtures thereof.

4. The mixture composition of claim 1, wherein the mixture also comprises one or more conventional cellulose ethers selected from the group consisting of methylcellulose (MC), methylhydroxyethylcellulose (MHEC), methylhydroxypropylcellulose (MHPC), hydroxyethylcellulose (HEC), ethylhydroxyethylcellulose (EHEC), hydrophobically modified hydroxyethylcellulose (HMHEC), hydrophobically modified ethylhydroxyethylcellulose (HMEHEC), methylethylhydroxyethylcellulose (MEHEC), sulfoethyl methylhydroxyethylcelluloses (SEMHEC), sulfoethyl methylhydroxypropylcelluloses (SEMHPC), and sulfoethyl hydroxyethylcelluloses (SEHEC).

5. The mixture composition of claim 1, wherein the amount of the cellulose ether is 70 to 99 wt %.

6. The mixture composition of claim 1, wherein the amount of the additive is 0.5 to 30 wt %.

7. The mixture composition of claim 1, wherein the at least one additive is an organic thickening agent selected from the group consisting of polysaccharides.

8. The mixture composition of claim 7, wherein the polysaccharides are selected from the group consisting of starch ether, starch, guar, guar derivatives, dextran, chitin, chitosan, xylan, xanthan gum, welan gum, gellan gum, mannan, galactan, glucan, arabinoxylan, alginate, and cellulose fibres.

9. The mixture composition of claim 1, wherein the at least one additive is selected from the group consisting of homo- or co-polymers of acrylamide, gelatin, polyethylenegylcol, casein, lignin sulfonates, naphthalene-sulfonate, sulfonated melamine-formaldehyde condensate, sulfonated naphthalene-formaldehyde condensate, polyacrylates, polycarboxylate ether, polystyrene sulphonates, phosphates, phosphonates, calcium-salts of organic acids having 1 to 4 carbon atoms, salts of alkanoates, aluminum sulfate, metallic aluminum, bentonite, montmorillonite, sepiolite, polyamide fibres, polypropylene fibres, polyvinylalcohol, and homo-, co-, or terpolymers based on vinyl acetate, maleic ester, ethylene, styrene, butadiene, vinyl versatate, and acrylic monomers.

10. The mixture composition of claim 1, wherein the at least one additive is selected from the group consisting of calcium chelating agents, fruit acids, and surface active agents.

11. The mixture composition of claim 1, wherein the significantly reduced amount of the mixture used in the mortar is at least 5% reduction.

12. The mixture composition of claim 1, wherein the significantly reduced amount of the mixture used in the mortar is at least 10% reduction.

13. The mixture composition of claim 3, wherein the mixture composition is MHEC and an additive selected from the group consisting of homo-or co-polymers of acrylamide, starch ether, and mixtures thereof.

14. The mixture composition of claim 13, wherein the co-polymers of acrylamide are selected from the group consisting of poly(acrylamide-co-sodium acrylate), poly(acrylamide-co-acrylic acid), poly(acrylamide-co-sodium-acrylamido methylpropanesulfonate), poly(acrylamide-co-acrylamido methylpropanesulfonic acid), poly(acrylamide-co-diallyldimethylammonium chloride), poly(acrylamide-co-(acryloylamino)propyltrimethylammoniumchloride), poly(acrylamide-co-(acryloyl)ethyltrimethylammoniumchloride), and mixtures thereof.

15. The mixture composition of claim 13, wherein the starch ether is selected from the group consisting of hydroxyalkylstarches where the alkyl has 1 to 4 carbon atoms, carboxymethylated starch ethers, and mixtures thereof.

16. The mixture composition of claim 3, wherein the mixture is MHPC and an additive selected from the group consisting of homo-or co-polymers of acrylamide, starch ether, and mixtures thereof.

17. The mixture composition of claim 16, wherein the co-polymers of acrylamide are selected from the group consisting of poly(acrylamide-co-sodium-acrylate), poly(acrylamide-co-acrylic acid), poly(acrylamide-co-sodium acrylamido methylpropanesulfonate), poly(acrylamide-co-acrylamido methylpropanesulfonic acid), poly(acrylamide-co-diallyldimethylammonium chloride), poly(acrylamide-co-(acryloylamino)propyltrimethylammoniumchloride), poly(acrylamide-co-(acryloyl)ethyltrimethylammoniumchloride), and mixtures thereof.

18. The mixture composition of claim 16, wherein the starch ether is selected from the group consisting of hydroxyalkylstarches where the alkyl has 1 to 4 carbon atoms, carboxymethylated starch ethers, and mixtures thereof.

19. A dry tile cement mortar composition comprising hydraulic cement, fine aggregate material, and a water-retaining agent of at least one cellulose ether prepared from raw cotton linters,
wherein the dry tile cement mortar composition, when mixed with a sufficient amount of water, produces a mortar which can be applied in thin layers for setting tiles on substrates wherein the amount of the water retention agent in the mortar is significantly reduced while correction time, applicability, and sag resistance of the mortar are comparable or improved as compared to when using conventional similar cellulose ethers.

20. The dry tile cement mortar composition of claim 19, wherein the cellulose ether is selected from the group consisting of alkylhydroxyalkyl celluloses and hydroxyalkyl celluloses and mixtures thereof, prepared from raw cotton linters.

21. The dry tile cement mortar composition of claim 20, wherein the alkyl group of the alkylhydroxyalkyl celluloses has 1 to 24 carbon atoms and the hydroxyalkyl group has 2 to 4 carbon atoms.

22. The dry tile cement mortar composition of claim 19, wherein the at least one cellulose ether is selected from the group consisting of methylhydroxyethylcelluloses (MHEC), methylhydroxypropylcelluloses (MHPC), hydroxyethylcelluloseS (HEC), methylethylhydroxyethylcelluloses (MEHEC), ethylhydroxyethylcelluloses (EHEC), hydrophobically modified ethylhydroxyethylcelluloses (HMEHEC), hydrophobically modified hydroxyethylcelluloses (HMHEC) and mixtures thereof.

23. The dry tile cement mortar composition of claim 22, wherein the cellulose ether, where applicable, has a methyl or ethyl degree of substitution of 0.5 to 2.5, hydroxyethyl or hydroxypropyl molar substitution (MS) of 0.01 to 6, and molar substitution (MS) of the hydrophobic substituents of 0.01-0.5 per anhydroglucose unit.

24. The dry tile cement mortar composition of claim 19, wherein the dry tile cement mortar composition also comprises one or more conventional cellulose ethers selected from the group consisting of methylcellulose (MC), methylhydroxyethylcelluloses (MHEC), methylhydroxypropylcelluloses (MHPC), hydroxyethylcelluloseS (HEC), methylethylhydroxyethylcelluloses (MEHEC), ethyl hydroxyethylcelluloses (EHEC), hydrophobically modified ethyl hydroxyethylcelluloses (HMEHEC), hydrophobically modified hydroxyethylcelluloses (HMHEC), sulfoethyl methylhydroxyethylcelluloses (SEMHEC), sulfoethyl methylhydroxypropylcelluloses (SEMHPC), sulfoethyl hydroxyethylcelluloses (SEHEC), and mixtures thereof.

25. The dry tile cement mortar composition of claim 19, wherein the amount of cellulose ether is between 0.1 and 2.0 wt %.

26. The dry tile cement mortar composition of claim 19 in combination with one or more additives selected from the group consisting of organic or inorganic thickening agents, anti-sag agents, air entraining agents, wetting agents, defoamers, superplasticizers, dispersants, calcium-complexing agents, retarders, accelerators, water repellants, redispersible powders, biopolymers, and fibres.

27. The dry tile cement mortar composition of claim 19, wherein the one or more additives are selected from the group consisting of polyacrylamide, starch ether, starch, guar/guar derivatives, dextran, chitin, chitosan, xylan, xanthan gum, welan gum, gellan gum, mannan, galactan, glucan, gelatin, alginate, arabinoxylan, polyethylenegylcol, casein, lignin sulfonates, naphthalene-sulfonate, sulfonated melamine-formaldehyde condensate, sulfonated naphthalene-formaldehyde condensate, polyacrylates, polycarboxylateether, polystyrene sulphonates, phosphates, phosphonates, calcium-salts of organic acids having 1 to 4 carbon atoms, salts of alkanoates, aluminum sulfate, metallic aluminum, bentonite, montmorillonite, sepiolite, cellulose fibres, polyamide fibres, polypropylene fibres, and homo-, co-, or terpolymers based on vinyl acetate, maleic ester, ethylene, styrene, butadiene, vinyl versatate, and acrylic monomers.

28. The dry tile cement mortar composition of claim 19, wherein the at least one additive is selected from the group consisting of calcium chelating agents, fruit acids, and surface active agents.

29. The dry tile cement mortar composition of claim 19, wherein the amount of additives is from 0.001 and 15 wt %.

30. The dry tile cement mortar composition of claim 19, wherein the fine aggregate material is selected from the group consisting of silica sand, dolomite, limestone, lightweight aggregates, rubber crumbs, and fly ash.

31. The dry tile cement mortar composition of claim 30, wherein the light weight aggregates are selected from the group consisting of perlite, expanded polystyrene, and hollow glass spheres.

32. The dry tile cement mortar composition of claim 19, wherein the fine aggregate material is present in the amount of 20-90 wt %.

33. The dry tile cement mortar composition of claim 19, wherein the fine aggregate material is present in the amount of 50-70 wt %.

34. The dry tile cement mortar composition of claim 19, wherein the hydraulic cement is selected from the group consisting of Portland cement, Portland-slag cement, Portland-silica fume cement, Portland-pozzolana cement, Portland-burnt shale cement, Portland-limestone cement, Portland-composite cement, blastfurnace cement, pozzolana cement, composite cement and calcium aluminate cement.

35. The dry tile cement mortar composition of claim 19, wherein the hydraulic cement is present in the amount of 10-80 wt %.

36. The dry tile cement mortar composition of claim 19, wherein the hydraulic cement is present in the amount of 20-50 wt %.

37. The dry tile cement mortar composition of claim 19 in combination with at least one mineral binder selected from the group consisting of hydrated lime, gypsum, pozzolana, blast furnace slag, and hydraulic lime.

38. The dry tile cement mortar composition of claim 37, wherein the at least one mineral binder is present in the amount of 0.1-30 wt %.

39. The dry tile cement mortar composition of claim 22, wherein the MHEC and MHPC have a Brookfield aqueous solution viscosity of greater than 80,000 mPas as measured on a Brookfield RVT viscometer at 2 wt %, 20° C., and 20 rpm using a spindle number 7.

40. The dry tile cement mortar composition of claim 22, wherein the MHEC and MHPC have a Brookfield aqueous solution viscosity of greater than 90,000 mPas as measured on a Brookfield RVT viscometer at 2 wt %, 20° C. and 20 rpm using a spindle number 7.

41. The dry tile cement mortar composition of claim 19, wherein the significantly reduced amount of the cellulose ether used in the mortar is at least 5% reduction.

42. The dry tile cement mortar composition of claim 19, wherein the significantly reduced amount of the cellulose ether used in the mortar is at least 10% reduction.

43. The dry tile cement mortar composition of claim 22, wherein the tile cement mortar composition is a cellulose ether selected from the group consisting of MHEC and MHPC, and an additive selected from the group consisting of homo-or co-polymers of acrylamide, starch ether, and mixtures thereof.

44. The dry tile cement mortar composition of claim 43, wherein the co-polymers of acrylamide are selected from the group consisting of poly(acrylamide-co-sodium acrylate), poly(acrylamide-co-acrylic acid), poly(acrylamide-co-sodium-acrylamido methylpropanesulfonate), poly(acrylamide-co-acrylamido methylpropanesulfonic acid), poly(acrylamide-co-diallyldimethylammonium chloride), poly(acrylamide-co-(acryloylamino)propyltrimethylammoniumchloride), poly(acrylamide-co-(acryloyl)ethyltrimethylammoniumchloride), and mixtures thereof.

45. The dry tile cement mortar composition of claim 43, wherein the starch ether is selected from the group consisting of hydroxyalkylstarches where the alkyl group has 1 to 4 carbon atoms, carboxymethylated starch ethers, and mixtures thereof.
